(19) United States
(12) Patent Application Publication
(10) Pub. No.: US 2006/0264556 A1
(43) Pub. Date: Nov. 23, 2006

(54) Fiber reinforced polypropylene composite body panels

(76) Inventors: Arnold Lustiger, Edison, NJ (US); Jeffrey Valentage, Royal Oak, MI (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/387,502

(22) Filed: Mar. 23, 2006

Related U.S. Application Data
(63) Continuation-in-part of application No. 11/318,363, filed on Dec. 23, 2005.
Application No. 11/318,363 is a continuation-in-part of application No. 11/301,533, filed on Dec. 13, 2005.
(60) Provisional application No. 60/681,609, filed on May 17, 2005.

(51) Int. Cl. C08K 3/34

(52) U.S. Cl. 524/451; 524/456

(57) ABSTRACT

A fiber reinforced polypropylene composite vehicle body panel. The vehicle body panel includes a substrate molded from a composition comprising at least 30 wt % polypropylene based resin, from 10 to 60 wt % organic fiber, from 0 to 40 wt % inorganic filler, and optionally lubricant (typically present at from 0 to 0.1 wt %), based on the total weight of the composition, the substrate having an outer surface and an underside surface. A process for producing a body panel for a vehicle is also provided. The process includes the step of molding a composition to form the body panel for a vehicle, the body panel having at least an outer surface and an underside surface, wherein the composition comprises at least 30 wt % polypropylene, from 10 to 60 wt % organic fiber, from 0 to 40 wt % inorganic filler, and optionally lubricant (typically present at from 0 to 0.1 wt %), based on the total weight of the composition.

### CROSS-REFERENCE TO RELATED APPLICATIONS

This application is a Continuation-in-Part of U.S. patent application Ser. No. 11/318,363, filed Dec. 23, 2005, which is a Continuation-in-Part of U.S. patent application Ser. No. 11/301,533, filed Dec. 13, 2005, and claims priority to U.S. Provisional Application Ser. No. 60/681,609 filed May 17, 2005, the contents of each are hereby incorporated by reference.

### FIELD OF THE INVENTION

The present invention is directed generally to vehicle body panels and the like produced from fiber reinforced polypropylene compositions and to processes for making such panels. The present invention is also directed to the molding of panels produced from fiber reinforced polypropylene compositions.

### BACKGROUND OF THE INVENTION

In the molding of automobile parts, such as body panels and the like, injection molding, thermoforming and structural molded compound (SMC) processes have been employed using a variety of materials. Attempts are underway in the automotive industry to produce ever larger molded plastic parts, particularly in the area of outer body panels. As is widely appreciated, plastic parts have the advantage of light weight, corrosion resistance and lower cost.

Polyolefins have seen limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced which address the toughness issue. For example, it is known to increase the toughness of polypropylene by adding rubber particles, either in-reactor resulting in impact copolymers, or through post-reactor blending. However, while toughness is improved, stiffness is considerably reduced using this approach.

Injection molding of thermoplastic resin has been used for many small articles. While some larger articles have been made, the parts have not served structural purposes. For example, fenders and doors have been made by injection molding. As may be appreciated, fenders and doors are not load-bearing, have little structural integrity and must be attached to the frame of the car body. Further, the outer surfaces must be painted or be molded in conjunction with a polymeric skin layer, since surface flaws are inherent.

Resin transfer molding (RTM) has been used to make certain external body parts. In this process, a glass or graphite pre-form is positioned in a mold and a liquid thermosetting resin is injected into the mold. The thermosetting resin solidifies and forms the body of the part. Such parts typically require structural support and have a relatively poor surface finish. Parts produced by RTM have traditionally been painted, since the surface finish has not otherwise been satisfactory.

Thermosetting polyester filled with chopped fibers has been compression molded into relatively large sheets or panels. Despite many attempts to produce panels having a high quality surface finish, the surface finish obtained is not particularly good.

Glass reinforced polypropylene compositions have been introduced to improve stiffness. However, the glass fibers have a tendency to break in typical injection molding equipment, resulting in reduced toughness and stiffness. In addition, glass reinforced products have a tendency to warp after injection molding.

Thermoplastic resins employing glass fibers have been extruded in sheet form. Glass fibers have also been used as a laminate in thermoplastic resin sheet form. The sheets can then be compression molded to a particular shape. As may be appreciated by those skilled in the art, compression molding has certain limitations since compression molded parts cannot be deeply drawn and thus must possess a relatively shallow configuration. Additionally, such parts are not particularly strong and require structural reinforcements when used in the production of vehicle body panels. Moreover, the surface finish of glass-filled resins is generally poor.

The automotive industry generally requires that all surfaces visible to the consumer have “class A” surface quality. At a minimum, such surfaces must be smooth, glossy, and weatherable. Components made of glass-filled compositions often require extensive surface preparation and the application of a curable coating to provide a surface of acceptable quality and appearance. The steps required to prepare such a surface may be expensive and time consuming and may affect mechanical properties.

Although the as-molded surface quality of glass-filled components continues to improve, imperfections in their surfaces due to exposed glass fibers, glass fiber read-through, and the like often occur. These surface imperfections may further result in imperfections in coatings applied to such surfaces. Defects in the surface of glass-filled compositions and in-cured coatings applied to the surfaces of glass-filled compositions may manifest as paint popping, high long- and short-term wave scan values, orange peel, variations in gloss or the like.

Several techniques have been proposed to provide surfaces of acceptable appearance and quality. For example, overmolding of thin, preformed paint films may provide a desired Class A surface. However, such overmolding is usually applicable only for those compositions capable of providing virgin molded surfaces that do not require any secondary surface preparation operations. Although as-molded surface quality has improved, as-molded surfaces of component parts continue to require sanding, especially at the edges, followed by sealing and priming prior to painting. In-mold coating can obviate these operations, but only at the cost of greatly increased cycle time and cost. Such processes use expensive paint systems that may be applied to the part surface while the mold is re-opened slightly, and then closed to distribute and cure the coating.

As an alternative to the use of glass fibers, another known method of improving the properties of polyolefins is organic fiber reinforcement. For example, EP Patent Application No. 0397881, discloses a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., discloses a composition including a polymer, such as polypropylene, and uniformly dispersed therein at least about 10% by weight of the composition staple length fiber, the fiber being of man-made polymers, such as poly(ethylene terephthalate) (PET) or poly(1,4-cyclohexylenedimethylene terephthalate).

Fiber reinforced polypropylene compositions are also disclosed in PCT Publication WO 02/053629. More specifically, WO 02/053629 discloses a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522, the entire disclosures of which are hereby incorporated herein by reference.

U.S. Pat. No. 3,304,282 to Cadus et al. discloses a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent discloses an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. discloses a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. discloses an impregnation process for preparing pellets of a synthetic organic fiber reinforced polyolefin. The process comprises the steps of heating a polyolefin at the temperature which is higher than the melting point thereof by 40 degree C. or more to lower than the melting point of a synthetic organic fiber to form a molten polyolefin; passing a reinforcing fiber comprising the synthetic organic fiber continuously through the molten polyolefin within six seconds to form a polyolefin impregnated fiber; and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. discloses a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

application Ser. No. 11/318,363, filed Dec. 23, 2005, notes that consistently feeding PET fibers into a compounding extruder is a problem encountered during the production of polypropylene (PP)-PET fiber composites. Conventional gravimetric or vibrational feeders used in the metering and conveying of polymers, fillers and additives into the extrusion compounding process, while effective in conveying pellets or powder, are not effective in conveying cut fiber. Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configuration may impact the dispersion of PET fibers within the PP matrix, and extrusion compounding processing conditions may impact not only the mechanical properties of the matrix polymer, but also the mechanical properties of the PET fibers. Application Ser. No. 11/318,363, filed Dec. 23, 2005, proposes solutions to these problems.

A need exists for a composite vehicle body panel having improved stiffness, surface finish, impact resistance and flexural modulus characteristics and for a process for making such fiber reinforced polypropylene composite vehicle body panels.

### SUMMARY OF THE INVENTION

Provided is a fiber reinforced polypropylene composite vehicle body panel. The vehicle body panel includes a substrate molded from a composition comprising at least 30 wt % polypropylene based resin, from 10 to 60 wt % organic fiber, from 0 to 40 wt % inorganic filler, and optionally lubricant (typically present at from 0 to 0.1 wt %), based on the total weight of the composition, the substrate having an outer surface and an underside surface.

In another aspect, provided is a process for producing a body panel for a vehicle is also provided. The process includes the step of molding a composition to form the body panel for a vehicle, the body panel having at least an outer surface and an underside surface, wherein the composition comprises at least 30 wt % polypropylene, from 10 to 60 wt % organic fiber, from 0 to 40 wt % inorganic filler, and optionally lubricant (typically present at from 0 to 0.1 wt %), based on the total weight of the composition.

In yet another aspect, provided is a process for making fiber reinforced polypropylene composite vehicle body panels, comprising the steps of: feeding into a twin screw extruder hopper at least about 25 wt % of a polypropylene based resin with a melt flow rate of from about 20 to about 1500 g/10 minutes; continuously feeding by unwinding from one or more spools into the twin screw extruder hopper from about 5 wt % to about 40 wt % of an organic fiber; feeding into a twin screw extruder from about 10 wt % to about 60 wt % of an inorganic filler; extruding the polypropylene based resin, the organic fiber, and the inorganic filler through the twin screw extruder to form a fiber reinforced polypropylene composite melt; cooling the fiber reinforced polypropylene composite melt to form a solid fiber reinforced polypropylene composite; molding the fiber reinforced polypropylene composite to form the body panel for a vehicle, the body panel having an outer surface and an underside surface.

It has surprisingly been found that high quality composite vehicle body panels can be produced from substantially lubricant-free fiber reinforced polypropylene compositions, the resultant panels possessing a flexural modulus of at least 300,000 psi and exhibiting ductility during instrumented impact testing. Particularly surprising is the ability to make such composite vehicle body panels using a wide range of polypropylenes as the matrix material, including some polypropylenes that, without fiber, are very brittle.

It has also been surprisingly found that organic fiber may be fed into a twin screw compounding extruder by continuously unwinding from one or more spools into the feed hopper of the twin screw extruder, and then chopped into ¼ inch to 1 inch lengths by the twin screws to form a fiber reinforced polypropylene based composite for use in producing high quality composite vehicle body panels.

Numerous advantages result from the composite vehicle body panels and the method of making disclosed herein and the uses/applications therefore.

For example, in exemplary embodiments of the present disclosure, the disclosed polypropylene fiber composite vehicle body panels exhibit improved instrumented impact resistance.

In a further exemplary embodiment of the present disclosure, the disclosed polypropylene fiber composite vehicle body panels exhibit improved flexural modulus.

In a further exemplary embodiment of the present disclosure, the disclosed polypropylene fiber composite vehicle body panels do not splinter during instrumented impact testing.

In yet a further exemplary embodiment of the present disclosure, the disclosed polypropylene fiber composite vehicle body panels exhibit fiber pull out during instrumented impact testing without the need for lubricant additives.

In yet a further exemplary embodiment of the present disclosure, the disclosed polypropylene fiber composite vehicle body panels exhibit a higher heat distortion temperature compared to rubber toughened polypropylene.

In yet a further exemplary embodiment of the present disclosure, the disclosed polypropylene fiber composite vehicle body panels exhibit a lower flow and cross flow coefficient of linear thermal expansion compared to rubber toughened polypropylene.

In still yet a further exemplary embodiment of the present disclosure, the disclosed polypropylene fiber composite vehicle body panels exhibit the ability to provide class A surface finishes.

In still yet a further exemplary embodiment of the present disclosure, the disclosed polypropylene fiber composite vehicle body panels exhibit the requisite stiffness characteristics necessary for use as horizontal body panels, such as hoods, deck lids and roofs.

These and other advantages, features and attributes of the disclosed polypropylene fiber composite vehicle body panels, and method of making of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 is a frontal perspective view showing fiber reinforced polypropylene composite body panels used to form the body of an automobile;

FIG. 2 is a rear perspective view showing fiber reinforced polypropylene composite body panels used to form the body of an automobile;

FIG. 3 is a top plan view of a fiber reinforced polypropylene composite automobile hood;

FIG. 4 is a cross-sectional view of the FIG. 3 fiber reinforced polypropylene composite automobile hood taken along line 4-4;

FIG. 5 depicts an exemplary schematic of the process for making fiber reinforced polypropylene composites of the instant invention;

FIG. 6 depicts an exemplary schematic of a twin screw extruder with a downstream feed port for making fiber reinforced polypropylene composites of the instant invention; and

FIG. 7 depicts an exemplary schematic of a twin screw extruder screw configuration for making fiber reinforced polypropylene composites of the instant invention.

### DETAILED DESCRIPTION OF THE INVENTION

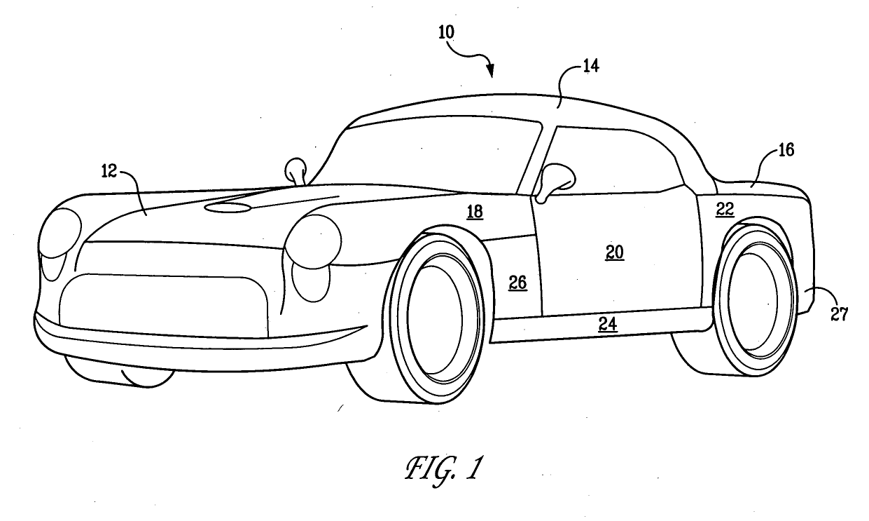

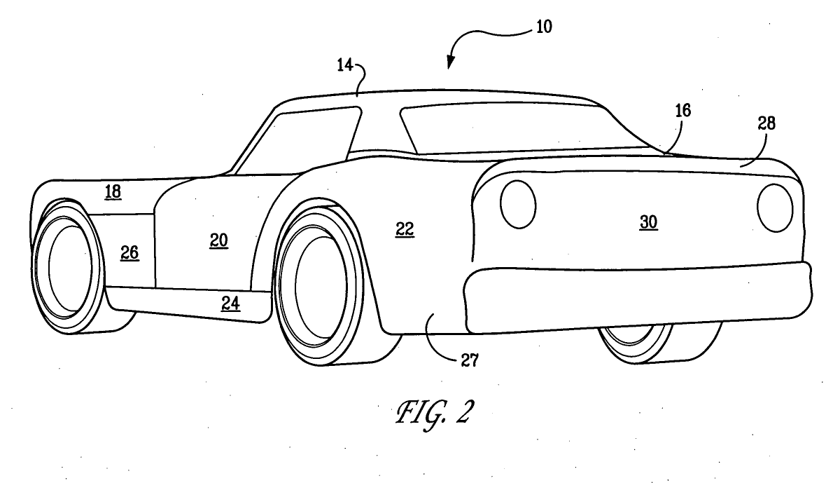

Reference is now made to FIGS. 1-7, wherein like numerals are used to designate like parts throughout.

Disclosed herein are improved fiber reinforced polypropylene composite vehicle body panels and a process for making same. Composite vehicle body panels of the type contemplated herein are generically depicted in FIGS. 1-4 for a vehicle 10. Referring to FIGS. 12, exemplary body panels include a three-dimensionally contoured hood 12, front fenders 18, outer door panels 20, rear fenders 22, deck lid panel 16, rocker panels 24, spoiler 28, front quarter panels 26, rear quarter panels 27, rear panel 30 and roof 14. As may be appreciated by those skilled in the art, other panels may also be formed, such as, interior trim panels, fuel filler doors, and exterior and interior garnish moldings.

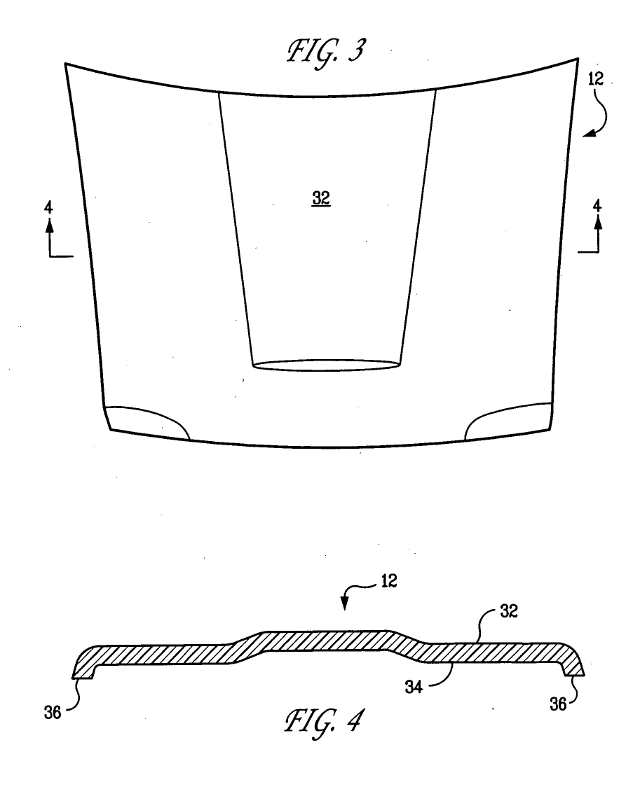

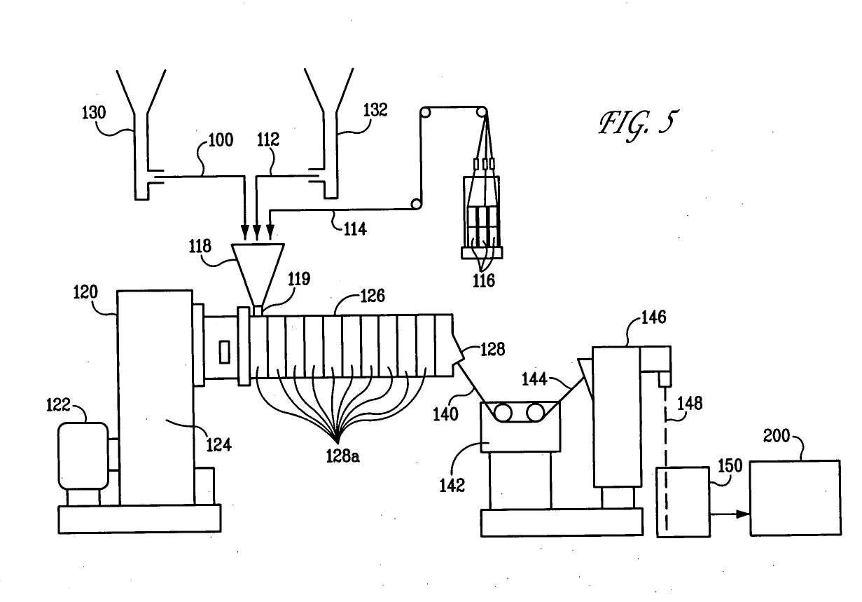

Referring to FIGS. 3-4 (4 is cross-section taken at Line 4-4 in FIG. 3), hood 12 has an outer surface 32 and an underside surface 34, each of which terminates at peripheral edges 36. Peripheral edges 36 may be downwardly turned as shown, cut along generally vertical planes or provided with a partial radius.

Advantageously, outside surface 32 of hood 12 is provided with a class A exterior surface exhibiting extremely high finish quality characteristics, free of aesthetic blemishes and defects. As may be appreciated and will be explained in more detail below, the other exemplary body panels described herein may also be provided with a class A exterior surfaces.

The fiber reinforced polypropylene composite vehicle body panels contemplated herein are molded from a composition comprising a combination of a polypropylene based matrix with organic fiber and inorganic filler, which in combination advantageously yield body panels with a flexural modulus of at least 300,000 psi and ductility during instrumented impact testing (15 mph, −29° C., 25 lbs). The fiber reinforced polypropylene body panels employ a polypropylene based matrix polymer with an advantageous high melt flow rate without sacrificing impact resistance. In addition, the fiber reinforced polypropylene composite vehicle body panels disclosed herein do not splinter during instrumented impact testing.

The fiber reinforced polypropylene composite vehicle body panels contemplated herein simultaneously have desirable stiffness, as evidenced by possessing a flexural modulus of at least 300,000 psi, and toughness, as evidenced by possessing ductility during instrumented impact testing. The fiber reinforced polypropylene composite vehicle body panels have a flexural modulus of at least 350,000 psi, or at least 370,000 psi, or at least 390,000 psi, or at least 400,000 psi, or at least 450,000 psi. Still more particularly, the fiber reinforced polypropylene composite vehicle body panels have a flexural modulus of at least 600,000 psi, or at least 800,000 psi. It is also believed that having a weak interface between the polypropylene matrix and the fiber of the fiber reinforced polypropylene composite vehicle body panels contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix. In addition, in one embodiment, there is no need to add lubricant to weaken the interface between the polypropylene and the fiber to further enhance fiber pullout. Some embodiments also display no splintering during instrumented dart impact testing, which yield a further advantage of not subjecting a person in close proximity to the impact to potentially harmful splintered fragments.

The fiber reinforced polypropylene composite vehicle body panels disclosed herein are formed from a composition that includes at least 30 wt %, based on the total weight of the composition, of polypropylene as the matrix resin. In a particular embodiment, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another embodiment, the polypropylene is present in an amount of at least 25 wt %.

The polypropylene used as the matrix resin for use in the fiber reinforced polypropylene composite vehicle body panels contemplated herein is not particularly restricted and is generally selected from the group consisting of propylene homopolymers, propylene-ethylene random copolymers, propylene-α-olefin random copolymers, propylene block copolymers, propylene impact copolymers, and combinations thereof. In a particular embodiment, the polypropylene is a propylene homopolymer. In another particular embodiment, the polypropylene is a propylene impact copolymer comprising from 78 to 95 wt % homopolypropylene and from 5 to 22 wt % ethylene-propylene rubber, based on the total weight of the impact copolymer. In a particular aspect of this embodiment, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from about 20 to about 1500 g/10 min. In a particular embodiment, the melt flow rate of the polypropylene matrix resin is greater 100 g/10 min, and still more particularly greater than or equal to 400 g/10 min. In yet another embodiment, the melt flow rate of the polypropylene matrix resin is about 1500 g/10 min. The higher melt flow rate permits for improvements in processability, throughput rates, and higher loading levels of organic fiber and inorganic filler without negatively impacting flexural modulus and impact resistance.

In a particular embodiment, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular embodiment, the matrix polypropylene does not contain a modifier. In still yet another particular embodiment, the polypropylene based polymer further includes from about 0.1 wt % to less than about 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersant, lubricant, flame-retardant, antioxidant, antistatic agent, light stabilizer, ultraviolet light absorber, carbon black, nucleating agent, plasticizer, and coloring agent such as dye or pigment. The amount of additive, if present, in the polypropylene matrix is generally from 0.1 wt %, or 0.5 wt %, or 2.5 wt %, to 7.5 wt %, or 10 wt %, based on the total weight of the matrix. Diffusion of additive(s) during processing may cause a portion of the additive(s) to be present in the fiber.

The invention is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the invention is not limited to any particular catalyst for making the polypropylene, and may, for example, include Ziegler-Natta or metallocene catalysts.

The fiber reinforced polypropylene composite vehicle body panels contemplated herein are formed from compositions that also generally include at least 10 wt %, based on the total weight of the composition, of an organic fiber. In a particular embodiment, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another embodiment, the organic fiber is present in an amount of at least 5 wt % and up to 40 wt %.

The polymer used as the fiber is not particularly restricted and is generally selected from the group consisting of polyalkylene terephthalates, polyalkylene naphthalates, polyamides, polyolefins, polyacrylonitrile, and combinations thereof. In a particular embodiment, the fiber comprises a polymer selected from the group consisting of polyethylene terephthalate (PET), polybutylene terephthalate, polyamide and acrylic. In another particular embodiment, the organic fiber comprises PET.

In one embodiment, the fiber is a single component fiber. In another embodiment, the fiber is a multicomponent fiber wherein the fiber is formed from a process wherein at least two polymers are extruded from separate extruders and meltblown or spun together to form one fiber. In a particular aspect of this embodiment, the polymers used in the multicomponent fiber are substantially the same. In another particular aspect of this embodiment, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the fiber employed in the fiber reinforced polypropylene composite vehicle body panels contemplated herein are not particularly restricted. In a particular embodiment, the fibers have a length of ¼ inch, or a length within the range having a lower limit of ⅛ inch, or ⅙ inch, and an upper limit of ⅓ inch, or ½ inch. In another particular embodiment, the diameter of the fibers is within the range having a lower limit of 10 μm and an upper limit of 100 μm.

The fiber may further contain additives commonly known in the art, such as dispersants, lubricants, flame-retardants, antioxidants, antistatic agents, light stabilizers, ultraviolet light absorbers, carbon black, nucleating agents, plasticizers, and coloring agents, such as dye or pigment.

The fiber used in the fiber reinforced polypropylene composite vehicle body panels contemplated herein is not limited by any particular fiber form. For example, the fiber can be in the form of continuous filament yarn, partially oriented yarn, or staple fiber. In another embodiment, the fiber may be a continuous multifilament fiber or a continuous monofilament fiber.

The compositions employed in the fiber reinforced polypropylene composite vehicle body panels contemplated herein optionally include inorganic filler in an amount of at least 1 wt %, or at least 5 wt %, or at least 10 wt %, or in an amount within the range having a lower limit of 0 wt %, or 1 wt %, or 5 wt %, or 10 wt %, or 15 wt %, and an upper limit of 25 wt %, or 30 wt %, or 35 wt %, or 40 wt %, based on the total weight of the composition. In yet another embodiment, the inorganic filler may be included in the polypropylene fiber composite in the range of from 10 wt % to about 60 wt %. In a particular embodiment, the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, magnesium oxysulfate, titanium oxide, zinc oxide, zinc sulfate, and combinations thereof. The talc may have a size of from about 1 to about 100 microns.

Preferred for use in the compositions employed in the fiber reinforced polypropylene composite vehicle body panels contemplated herein is high aspect ratio talc. Although aspect ratio can be calculated by dividing the average particle diameter of the talc by the average thickness using a conventional microscopic method, this is a difficult and tedious technique. A particularly useful indication of aspect ratio is known in the art as “lamellarity index,” which is a ratio of particle size measurements. Therefore, as used herein, by “high aspect ratio” talc is meant talc having an average lamellarity index greater than or equal to about 4 or greater than or equal to about 5. A talc having utility in the compositions disclosed herein preferably has a specific surface area of at least 14 square meters/gram.

In one particular embodiment, at a high talc loading of up to about 60 wt %, the polypropylene fiber composite exhibited a flexural modulus of at least about 750,000 psi and no splintering during instrumented impact testing (15 mph, −29° C. and 25 lbs). In another particular embodiment, at a low talc loading of as low as 10 wt %, the polypropylene fiber composite exhibited a flexural modulus of at least about 325,000 psi and no splintering during instrumented impact testing (15 mph, −29° C. and 25 lbs). In addition, wollastonite loadings of from 5 wt % to 60 wt % in the polypropylene fiber composite yielded an outstanding combination of impact resistance and stiffness.

In another particular embodiment, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of greater than 100 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively

Composite vehicle body panels of the present invention are made by forming the fiber-reinforced polypropylene composition and then injection molding the composition to form the vehicle body panel. The invention is not limited by any particular method for forming the compositions. For example, the compositions can be formed by contacting polypropylene, organic fiber, and optional inorganic filler in any of the well known processes of pultrusion or extrusion compounding. In a particular embodiment, the compositions are formed in an extrusion compounding process. In a particular aspect of this embodiment, the organic fibers are cut prior to being placed in the extruder hopper. In another particular aspect of this embodiment, the organic fibers are fed directly from one or more spools into the extruder hopper.

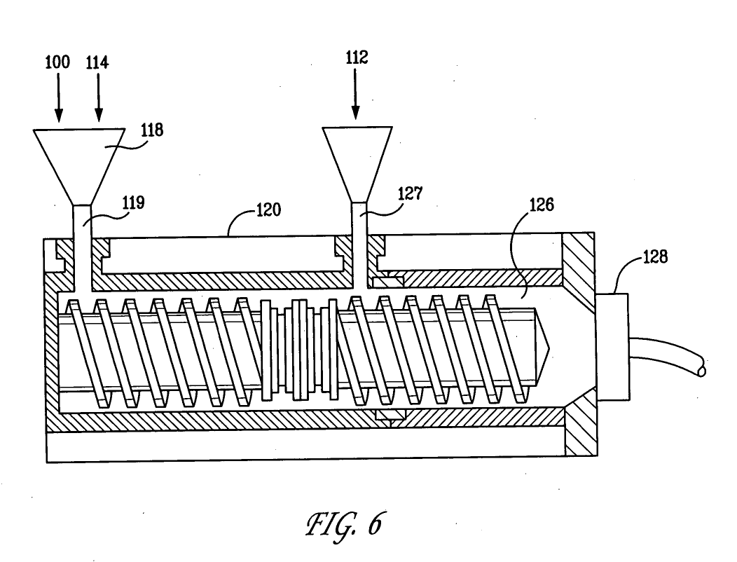

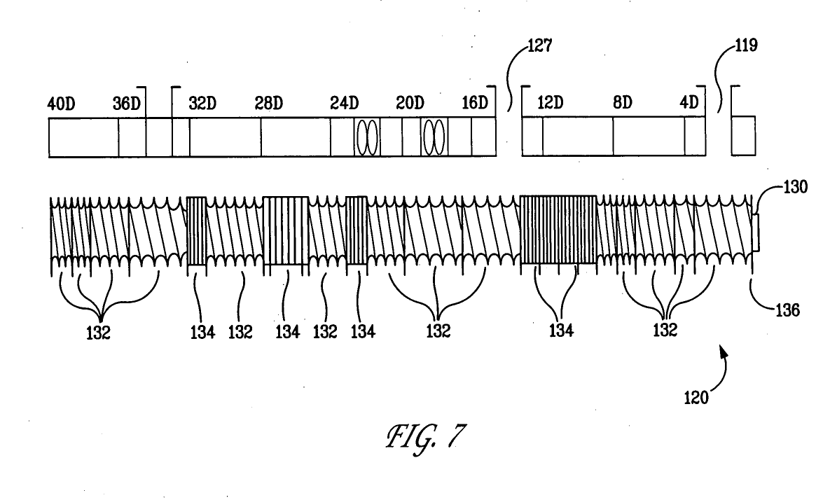

Referring now to FIG. 5 an exemplary schematic of the process for making fiber reinforced polypropylene composites of the instant invention is shown. Polypropylene based resin 100, inorganic filler 112, and organic fiber 114 continuously unwound from one or more spools 116 are fed into the extruder hopper 118 of a twin screw compounding extruder 120. The extruder hopper 118 is positioned above the feed throat 119 of the twin screw compounding extruder 120. The extruder hopper 118 may alternatively be provided with an auger (not shown) for mixing the polypropylene based resin 100 and the inorganic filler 112 prior to entering the feed throat 119 of the twin screw compounding extruder 120. In an alternative embodiment, as depicted in FIG. 6, the inorganic filler 112 may be fed to the twin screw compounding extruder 120 at a downstream feed port 127 in the extruder barrel 126 positioned downstream of the extruder hopper 118 while the polypropylene based resin 100 and the organic fiber 114 are still metered into the extruder hopper 118.

Referring again to FIG. 5, the polypropylene based resin 100 is metered to the extruder hopper 118 via a feed system 130 for accurately controlling the feed rate. Similarly, the inorganic filler 112 is metered to the extruder hopper 118 via a feed system 132 for accurately controlling the feed rate. The feed systems 130, 132 may be, but are not limited to, gravimetric feed system or volumetric feed systems. Gravimetric feed systems are particularly preferred for accurately controlling the weight percentage of polypropylene based resin 100 and inorganic filler 112 being fed to the extruder hopper 118. The feed rate of organic fiber 114 to the extruder hopper 118 is controlled by a combination of the extruder screw speed, number of fiber filaments and the thickness of each filament in a given fiber spool, and the number of fiber spools 116 being unwound simultaneously to the extruder hopper 118. The higher the extruder screw speed measured in revolutions per minute (rpms), the greater will be the rate at which organic fiber 114 is fed to the twin screw compounding screw 120. The rate at which organic fiber 114 is fed to the extruder hopper also increases with the greater the number of filaments within the organic fiber 114 being unwound from a single fiber spool 116, the greater filament thickness, the greater the number fiber spools 116 being unwound simultaneously, and the rotations per minute of the extruder.

The twin screw compounding extruder 120 includes a drive motor 122, a gear box 124, an extruder barrel 126 for holding two screws (not shown), and a strand die 128. The extruder barrel 126 is segmented into a number of heated temperature controlled zones 128. As depicted in FIG. 5, the extruder barrel 126 includes a total of ten temperature control zones 128. The two screws within the extruder barrel 126 of the twin screw compounding extruder 120 may be intermeshing or non-intermeshing, and may rotate in the same direction (co-rotating) or rotate in opposite directions (counter-rotating). From a processing perspective, the melt temperature must be maintained above that of the polypropylene based resin 100, and far below the melting temperature of the organic fiber 114, such that the mechanical properties imparted by the organic fiber will be maintained when mixed into the polypropylene based resin 100. In one exemplary embodiment, the barrel temperature of the extruder zones did not exceed 154° C. when extruding PP homopolymer and PET fiber, which yielded a melt temperature above the melting point of the PP homopolymer, but far below the melting point of the PET fiber. In another exemplary embodiment, the barrel temperatures of the extruder zones are set at 185° C. or lower.

An exemplary schematic of a twin screw compounding extruder 120 screw configuration for making fiber reinforced polypropylene composites is depicted in FIG. 7. The feed throat 119 allows for the introduction of polypropylene based resin, organic fiber, and inorganic filler into a feed zone of the twin screw compounding extruder 120. The inorganic filler may be optionally fed to the extruder 120 at the downstream feed port 127. The twin screws 130 include an arrangement of interconnected screw sections, including conveying elements 132 and kneading elements 134. The kneading elements 134 function to melt the polypropylene based resin, cut the organic fiber lengthwise, and mix the polypropylene based melt, chopped organic fiber and inorganic filler to form a uniform blend. More particularly, the kneading elements function to break up the organic fiber into about ⅛ inch to about 1 inch fiber lengths. A series of interconnected kneading elements 34 is also referred to as a kneading block. U.S. Pat. No. 4,824,256 to Haring, et al., herein incorporated by reference in its entirety, discloses co-rotating twin screw extruders with kneading elements. The first section of kneading elements 134 located downstream from the feed throat is also referred to as the melting zone of the twin screw compounding extruder 120. The conveying elements 132 function to convey the solid components, melt the polypropylene based resin, and convey the melt mixture of polypropylene based polymer, inorganic filler and organic fiber downstream toward the strand die 128 (see FIG. 5 and 6) at a positive pressure.

The position of each of the screw sections as expressed in the number of diameters (D) from the start 136 of the extruder screws 130 is also depicted in FIG. 7. The extruder screws in FIG. 7 have a length to diameter ratio of 40/1, and at a position 32D from the start 136 of screws 130, there is positioned a kneading element 134. The particular arrangement of kneading and conveying sections is not limited to that as depicted in FIG. 7, however one or more kneading blocks consisting of an arrangement of interconnected kneading elements 134 may be positioned in the twin screws 130 at a point downstream of where organic fiber and inorganic filler are introduced to the extruder barrel. The twin screws 130 may be of equal screw length or unequal screw length. Other types of mixing sections may also be included in the twin screws 130, including, but not limited to, Maddock mixers, and pin mixers.

Referring once again to FIG. 5, the uniformly mixed fiber reinforced polypropylene composite melt comprising polypropylene based polymer 100, inorganic filler 112, and organic fiber 114 is metered by the extruder screws to a strand die 128 for forming one or more continuous strands 140 of fiber reinforced polypropylene composite melt. The one or more continuous strands 140 are then passed into water bath 142 for cooling them below the melting point of the fiber reinforced polypropylene composite melt to form a solid fiber reinforced polypropylene composite strands 144. The water bath 142 is typically cooled and controlled to a constant temperature much below the melting point of the polypropylene based polymer. The solid fiber reinforced polypropylene composite strands 144 are then passed into a pelletizer or pelletizing unit 146 to cut them into fiber reinforced polypropylene composite resin 148 measuring from about ¼ inch to about 1 inch in length. The fiber reinforced polypropylene composite resin 148 may then be accumulated in containers 150 or alternatively conveyed to silos for storage and eventual conveyance to a thermoforming or injection molding line 200.

The present invention is further illustrated by means of the following examples, and the advantages thereto without limiting the scope thereof.

Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., and 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

P01020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ long polyester fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | wt % | | Total Energy | Instrumented Impact |
|---|---|---|---|---|
| Example # | PP3505G | wt % Fiber | (ft-lbf) | Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | Brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| Example | Impact Conditions/Applied | Energy | Impact Test |
| # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | | | |
|---|---|---|---|---|
| Test | PET fiber-reinforced | | Example 16 | |
| (Method) | PP7805 with talc | | PP8224 | |
| Flexural Modulus, Chord | 525,190 | psi | 159,645 | psi |
| (ISO 178) | | | | |
| Instrumented Impact at −30° C. | 6.8 | J | 27.5 | J |
| Energy to maximum load | | | | |
| 100 lbs at 5 MPH (ASTM D3763) | | | | |
| Notched Charpy Impact | 52.4 | kJ/m² | 5.0 | kJ/m² |
| at −40° C. (ISO 179/1eA) | | | | |
| Heat Deflection Temperature | 116.5° | C. | 97.6° | C. |
| at 0.45 Mpa, edgewise (ISO 75) | | | | |

| | | |
|---|---|---|
| Coefficient of Linear Thermal | 2.2/12.8 | 10.0/18.6 |
| Expansion, −30° C. to 100° C., | (E-5/° C.) | (E-5/° C.) |
| Flow/Crossflow (ASTM E831) | | |

### Illustrative Examples 17-18

In Examples 17-18, 30 wt % of either PP3505G or PP8224, 15 wt % 0.25″ long polyester fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | Flexural | Instrumented Impact |
|---|---|---|---|
| | | Modulus, | at −30° C. Energy |
| Exam- | Poly | Chord, psi | to maximum load25 lbs |
| ple | propylene, | (ISO 178) | at 15 MPH (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in examples 19-24, the samples displayed no splintering in drop weight testing at an −29° C., 15 miles per hour at 25 pounds.

### Illustrative Examples 25-26

Two materials, one containing 10% ¼ inch polyester fibers, 35% PP3505 polypropylene and 60% V3837 talc (example 25) , the other containing 10% ¼ inch polyester fibers, 25% PP3505 polypropylene homopolymer (example 26), 10% P01020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to failure | Cycles to failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 5. The screw configuration used is depicted in FIG. 7, and includes an arrangement of conveying and kneading elements. Talc, polypropylene and PET fiber were all fed into the extruder feed hopper located approximately two diameters from the beginning of the extruder screws (19 in the FIG. 7). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 |
|---|---|
| Specific Gravity | 1.3 |
| Tensile Modulus, Chord @ 23° C. | 541865 psi |
| Tensile Modulus, Chord @ 85° C. | 257810 psi |
| Flexural Modulus, Chord @ 23° C. | 505035 psi |
| Flexural Modulus, Chord @ 85° C. | 228375 psi |
| HDT @ 0.45 MPA | 116.1° C. |
| HDT @ 1.80 MPA | 76.6° C. |
| Instrumented impact @ 23° C. | 11.8 J D** |
| Instrumented impact @ −30° C. | 12.9 J D** |

**Ductile failure with radial cracks

In example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In example 29, the fiber was fed into a hopper placed 14 diameters down the extruder (27 in the FIG. 7). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin produced while all temperature zones of the extruder were set to 120° C. was injection molded and displayed the following properties:

TABLE 8

| | Example 30 |
|---|---|
| Flexural Modulus, Chord @ 23° C. | 467,932 psi |
| Instrumented impact @ 23° C. | 8.0 J D** |
| Instrumented impact @ −30° C. | 10.4 J D** |

**Ductile failure with radial cracks

In an alternate embodiment, this invention also relates to:

1. A fiber reinforced composite vehicle body panel, said vehicle body panel comprising a substrate molded from a composition comprising at least 30 wt % polypropylene based resin, from 10 to 60 wt % organic fiber, from 0 to 40 wt % inorganic filler, and optionally lubricant (typically present at from 0 to 0.1 wt %), based on the total weight of the composition, said substrate having an outer surface and an underside surface.

2. The fiber reinforced composite vehicle body panel of paragraph 1, wherein said polypropylene based resin is selected from the group consisting of polypropylene homopolymers, propylene-ethylene random copolymers, propylene-α-olefin random copolymers, propylene impact copolymers, and combinations thereof.

3. The fiber reinforced composite vehicle body panel of paragraph 1 or 2, wherein said polypropylene based resin is polypropylene homopolymer with a melt flow rate of from about 20 to about 1500 g/1 0 minutes.

4. The fiber reinforced composite vehicle body panel of any of paragraphs 1 to 3, wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

5. The fiber reinforced composite vehicle body panel of any of paragraphs 1 to 4, wherein said lubricant is selected from the group consisting of silicon oil, silicon gum, fatty amide, paraffin oil, paraffin wax, and ester oil.

6. The fiber reinforced composite vehicle body panel of any of paragraphs 1 to 5, wherein said organic fiber is selected from the group consisting of polyalkylene terephthalates, polyalkylene naphthalates, polyamides, polyolefins, polyacrylonitrile, and combinations thereof.

7. The fiber reinforced composite vehicle body panel of any of paragraphs 1 to 6, wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

8. The fiber reinforced composite vehicle body panel of any of paragraphs 1 to 7, wherein said vehicle body panel has a flexural modulus of at least 300,000 psi and exhibits ductility during instrumented impact testing

9. The fiber reinforced composite vehicle body panel of any of paragraphs 1 to 8, wherein the vehicle body panel is a hood.

10. The fiber reinforced composite vehicle body panel of any of paragraphs 1 through 8, wherein the vehicle body panel is a roof.

11. The fiber reinforced composite vehicle body panel of any of paragraphs 1 through 8, wherein the vehicle body panel is a deck lid.

12. The fiber reinforced composite vehicle body panel of any of paragraphs 1 through 8, wherein the vehicle body panel is a door.

13. The fiber reinforced composite vehicle body panel of any of paragraphs 1 through 8, wherein the vehicle body panel is a front or rear fender.

14. The fiber reinforced composite vehicle body panel of any of paragraphs 1 through 8, wherein the vehicle body panel is a rocker panel.

15. The fiber reinforced composite vehicle body panel of any of paragraphs 1 through 8, wherein the vehicle body panel is a front or rear quarter panel.

16. The fiber reinforced composite vehicle body panel of any of paragraphs 1 to 15, wherein at least said outer surface of said substrate is provided with a class A surface finish.

17. A process for producing a body panel for a vehicle, the process comprising the step of molding a composition to form the body panel for a vehicle, the body panel having at least an outer surface and an underside surface, wherein the composition comprises at least 30 wt % polypropylene, from 10 to 60 wt % organic fiber, from 0 to 40 wt % inorganic filler, and optionally lubricant (typically present at from 0 to 0.1 wt %), based on the total weight of the composition.

18. The process of paragraph 17, wherein the vehicle body panel has a flexural modulus of at least 300,000 psi and exhibits ductility during instrumented impact testing

19. The process of paragraphs 17 or 18, further comprising the following steps:

(a) feeding into a twin screw extruder hopper at least about 25 wt % of a polypropylene based resin with a melt flow rate of from about 20 to about 1500 g/10 minutes;

(b) continuously feeding by unwinding from one or more spools into the twin screw extruder hopper from about 5 wt % to about 40 wt % of an organic fiber;

(c) feeding into a twin screw extruder from about 10 wt % to about 60 wt % of an inorganic filler;

(d) extruding the polypropylene based resin, the organic fiber, and the inorganic filler through the twin screw extruder to form a fiber reinforced polypropylene composite melt; and

(e) cooling the fiber reinforced polypropylene composite melt to form a solid fiber reinforced polypropylene composite;

wherein steps (a)-(e) are conducted prior to said molding step.

20. The process of any of paragraphs 17 through 19, further comprising the step of:

(g) providing at least the outer surface of the vehicle body panel with a class A surface finish.

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains.

When numerical lower limits and numerical upper limits are listed herein, ranges from any lower limit to any upper limit are contemplated.

We claim:

1. A fiber reinforced composite vehicle body panel, said vehicle body panel comprising a substrate molded from a composition comprising at least 30 wt % polypropylene based resin, from 10 to 60 wt % organic fiber, and from 0 to 40 wt % inorganic filler, based on the total weight of the composition, said substrate having an outer surface and an underside surface.

2. The fiber reinforced composite vehicle body panel of claim 1, wherein said polypropylene based resin is selected from the group consisting of polypropylene homopolymers, propylene-ethylene random copolymers, propylene-α-olefin random copolymers, propylene impact copolymers, and combinations thereof.

3. The fiber reinforced composite vehicle body panel of claim 2, wherein said polypropylene based resin is polypropylene homopolymer with a melt flow rate of from about 20 to about 1500 g/10 minutes.

4. The fiber reinforced composite vehicle body panel of claim 1, wherein said polypropylene based resin further comprises from about 0.1 wt % to less than about 10 wt % of a polypropylene based polymer modified with a grafting agent, wherein said grafting agent is selected from the group consisting of acrylic acid, methacrylic acid, maleic acid, itaconic acid, fumaric acid or esters thereof, maleic anhydride, itaconic anhydride, and combinations thereof.

5. The fiber reinforced composite vehicle body panel of claim of claim 1, wherein the composite comprises from 0 to 0.1 wt % lubricant selected from the group consisting of silicon oil, silicon gum, fatty amide, paraffin oil, paraffin wax, and ester oil.

6. The fiber reinforced composite vehicle body panel of claim 1, wherein said organic fiber is selected from the group consisting of polyalkylene terephthalates, polyalkylene naphthalates, polyamides, polyolefins, polyacrylonitrile, and combinations thereof.

7. The fiber reinforced composite vehicle body panel of claim 6, wherein said organic fiber is polyethylene terephthalate.

8. The fiber reinforced composite vehicle body panel of claim 1, wherein said inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

9. The fiber reinforced composite vehicle body panel of claim 8, wherein said inorganic filler is talc or wollastonite.

10. The fiber reinforced composite vehicle body panel of claim 1, wherein said vehicle body panel has a flexural modulus of at least 300,000 psi and exhibits ductility during instrumented impact testing

11. The fiber reinforced composite vehicle body panel of claim 1, wherein said vehicle body panel has a flexural modulus of at least 400,000 psi, and exhibits ductility during instrumented impact testing,

12. The fiber reinforced composite vehicle body panel of claim 1, wherein the vehicle body panel is substantially horizontally disposed on the vehicle.

13. The fiber reinforced composite vehicle body panel of claim 1, wherein the vehicle body panel is substantially vertically disposed on the vehicle.

14. The fiber reinforced composite vehicle body panel of claim 1, wherein the vehicle body panel is a hood.

15. The fiber reinforced composite vehicle body panel of claim 1, wherein the vehicle body panel is a roof.

16. The fiber reinforced composite vehicle body panel of claim 1, wherein the vehicle body panel is a deck lid.

17. The fiber reinforced composite vehicle body panel of claim 1, wherein the vehicle body panel is a door.

18. The fiber reinforced composite vehicle body panel of claim 1, wherein the vehicle body panel is a front or rear fender.

19. The fiber reinforced composite vehicle body panel of claim 1, wherein the vehicle body panel is a rocker panel.

20. The fiber reinforced composite vehicle body panel of claim 1, wherein the vehicle body panel is a front or rear quarter panel.

21. The fiber reinforced composite vehicle body panel of claim 1, wherein at least said outer surface of said substrate is provided with a class A surface finish.

22. A process for producing a body panel for a vehicle, the process comprising the step of molding a composition to form the body panel for a vehicle, the body panel having at least an outer surface and an underside surface, wherein the composition comprises at least 30 wt % polypropylene, and from 10 to 60 wt % organic fiber, from 0 to 40 wt % inorganic filler, based on the total weight of the composition.

23. The process of claim 22, wherein the vehicle body panel has a flexural modulus of at least 300,000 psi and exhibits ductility during instrumented impact testing.

24. The process of claim 22, wherein the composition is formed by a step comprising extrusion compounding to form an extrudate.

25. The process of claim 24, wherein the organic fiber is cut prior to the extrusion compounding step.

26. The process of claim 24, wherein during the extrusion compounding step, the organic fiber is a continuous fiber and is fed directly from one or more spools into an extruder hopper.

27. The process of claim 22, wherein the vehicle body panel is substantially horizontally disposed on the vehicle.

28. The process of claim 22, wherein the vehicle body panel is substantially vertically disposed on the vehicle.

29. The process of claim 22, wherein the vehicle body panel is a hood.

30. The process of claim 22, wherein the vehicle body panel is a roof.

31. The process of claim 22, wherein the vehicle body panel is a deck lid.

32. The process of claim 22, wherein the vehicle body panel is a door.

33. The process of claim 22, wherein the vehicle body panel is a front or rear fender.

34. The process of claim 22, wherein the vehicle body panel is a rocker panel.

35. The process of claim 22, wherein the vehicle body panel is a front or rear quarter panel.

36. The process of claim 22, further comprising the step of providing at least the outer surface of the vehicle body panel with a class A surface finish.

37. A process for making fiber reinforced polypropylene composite vehicle body panels, comprising the following steps:
(a) feeding into a twin screw extruder hopper at least about 25 wt % of a polypropylene based resin with a melt flow rate of from about 20 to about 1500 g/10 minutes;
(b) continuously feeding by unwinding from one or more spools into the twin screw extruder hopper from about 5 wt % to about 40 wt % of an organic fiber;
(c) feeding into a twin screw extruder from about 10 wt % to about 60 wt % of an inorganic filler;
(d) extruding the polypropylene based resin, the organic fiber, and the inorganic filler through the twin screw extruder to form a fiber reinforced polypropylene composite melt;
(e) cooling the fiber reinforced polypropylene composite melt to form a solid fiber reinforced polypropylene composite; and
(f) molding the fiber reinforced polypropylene composite to form the body panel for a vehicle, the body panel having an outer surface and an underside surface.

38. The process of claim 37, wherein the fiber reinforced polypropylene composite vehicle body panel has a flexural modulus of at least about 300,000 psi and exhibits ductility during instrumented impact testing.

39. The process of claim 37, wherein the polypropylene based resin is selected from the group consisting of polypropylene homopolymers, propylene-ethylene random copolymers, propylene-a-olefin random copolymers, propylene impact copolymers, and combinations thereof.

40. The process of claim 37, wherein the organic fiber is selected from the group consisting of polyalkylene terephthalates, polyalkylene naphthalates, polyamides, polyolefins, polyacrylonitrile, and combinations thereof.

41. The process of claim 40, wherein the organic fiber is polyethylene terephthalate.

42. The process of claim 37, wherein the inorganic filler is selected from the group consisting of talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

43. The process of claim 42, wherein the inorganic filler is talc or wollastonite.

44. The process of claim 37, wherein said step of feeding the inorganic filler into the twin screw extruder further comprises feeding the inorganic filler into the twin screw extruder hopper via a gravimetric feed system or feeding the inorganic filler into the twin screw extruder at a downstream injection port via a gravimetric feed system.

45. The process of claim 37, wherein said step of cooling the fiber reinforced polypropylene composite melt to form a solid fiber reinforced polypropylene composite is by continuously passing strands of the fiber reinforced polypropylene composite melt through a cooled water bath.

46. The process of claim 37, further comprising the step of:
(g) providing at least the outer surface of the vehicle body panel with a class A surface finish.
